(19) United States
(12) Patent Application Publication
(10) Pub. No.: US 2026/0120430 A1
(43) Pub. Date: Apr. 30, 2026

(54) METHODS AND SYSTEMS FOR IMAGE PROCESSING AND STORAGE MEDIA THEREOF

(71) Applicant: ZHEJIANG HUARAY TECHNOLOGY CO., LTD., Hangzhou (CN)

(72) Inventors: Hu HUANG, Hangzhou (CN); Yinchun HUANG, Hangzhou (CN); Lu ZHOU, Hangzhou (CN); Bo ZHANG, Hangzhou (CN)

(73) Assignee: ZHEJIANG HUARAY TECHNOLOGY CO., LTD., Hangzhou (CN)

(21) Appl. No.: 19/432,088

(22) Filed: Dec. 23, 2025

Related U.S. Application Data
(63) Continuation of application No. PCT/CN2024/101594, filed on Jun. 26, 2024.

(30) Foreign Application Priority Data
Jun. 26, 2023 (CN) 202310767480.3

(51) Int. Cl. G06V 10/74; G06V 10/22

(52) U.S. Cl. CPC G06V 10/761; G06V 10/22

(57) ABSTRACT

The provided methods include obtaining an image to be matched including multiple pixel points, for each of the multiple pixel points, obtaining pixel reference information of the pixel point including first reference information related to a pixel gradient of the pixel point and second reference information related to pixel values of both the pixel point and adjacent pixel points, determining whether the pixel point is a target pixel point based on the pixel reference information, the target pixel point being a pixel point whose pixel value is not a preset value, in response to the pixel point being the target pixel point, determining an initial similarity between the target pixel point and a pixel point in a template image, and determining the similarity between the image to be matched and the template image based on at least one initial similarity corresponding to at least one target pixel point.

### CROSS-REFERENCE TO RELATED APPLICATIONS

This application is a continuation of International Application No. PCT/CN2024/101594, filed on Jun. 26, 2024, which claims priority to Chinese Patent Application No. 202310767480.3, filed on Jun. 26, 2023, the entire contents of each of which are hereby incorporated by reference.

### TECHNICAL FIELD

The present disclosure relates to the field of image processing, and in particular, to methods and systems for determining image similarities and storage media thereof.

### BACKGROUND

Computer image processing is a widely used technology, and template matching is an important component of it. The template matching involves searching for a region in an image to be matched that most closely resembles the template image's features using specific algorithms, which is the first step in a machine vision application, and the accuracy and speed of its matching are critical to the success of the application. The template matching typically employs shape-based matching methods, which require extracting image edge features and calculating the similarity between the image to be matched and the template image based on these features. A common way to calculate the similarity is by computing the cosine angle, which involves a large amount of computation and tedious steps, resulting in inefficient template matching and high computational performance requirements.

Therefore, it is desirable to provide a method and a system for image processing and a storage medium to improve the efficiency of template matching and reduce the demand for computational performance.

### SUMMARY

One embodiment of the present disclosure provides a method implemented on a computing device including at least one processor and at least one storage device. The method includes obtaining an image to be matched. The image to be matched includes multiple pixel points. The method includes for each of the multiple pixel points, obtaining pixel reference information of the pixel point. The pixel reference information includes first reference information related to a pixel gradient of the pixel point and second reference information related to pixel values of both the pixel point and adjacent pixel points of the pixel point. The method includes determining, based on the pixel reference information, whether the pixel point is a target pixel point, the target pixel point being a pixel point whose pixel value is not a preset value. The method further includes in response to the pixel point being the target pixel point, determining an initial similarity between the target pixel point and a pixel point in a template image; and determining the similarity between the image to be matched and the template image based on at least one initial similarity corresponding to at least one target pixel point.

In some embodiments, the determining, based on the pixel reference information, whether the pixel point is a target pixel point includes determining whether the pixel reference information satisfies a first preset condition and in response to the pixel reference information satisfying the first preset condition, determining the pixel point being not the target pixel point. The first preset condition is set based on a comparison between the first reference information and a preset threshold. The method further includes setting the pixel value of the pixel point to the preset value.

In some embodiments, the preset threshold is determined based on a candidate feature. The candidate feature includes a contrast and a gradient magnitude statistical feature of the image to be matched.

In some embodiments, the candidate feature further includes a contrast of a candidate region in the image to be matched.

In some embodiments, the candidate feature corresponds to multiple candidate regions in the image to be matched, at least one of shapes or sizes of the multiple candidate regions being different, and the contrast of the candidate regions is determined based on a weighted calculation of the contrasts of the multiple candidate regions.

In some embodiments, the preset threshold is determined based on a processing speed requirement and the gradient magnitude statistical feature of the image to be matched.

In some embodiments, the determining, based on the pixel reference information, whether the pixel point is a target pixel point further includes in response to the pixel reference information not satisfying the first preset condition, determining whether the pixel reference information satisfies a second preset condition and in response to the pixel reference information satisfying the second preset condition, determining the pixel point being not the target pixel point. The second preset condition is set based on a comparison between the second reference information and a preset template. The method further includes setting the pixel value of the pixel point to the preset value.

In some embodiments, the adjacent pixel points of the pixel point include eight adjacent pixel points located around the pixel point with the pixel point as a center, and the preset template includes pixel values of two of the eight adjacent pixel points satisfying a third preset condition and the two adjacent pixel points being symmetrical relative to the pixel point.

In some embodiments, the adjacent pixel points of the pixel point include a first adjacent pixel point, a second adjacent pixel point, a third adjacent pixel point, a fourth adjacent pixel point, a fifth adjacent pixel point, a sixth adjacent pixel point, a seventh adjacent pixel point, and an eighth adjacent pixel point located around the pixel point with the pixel point as a center. The first to eighth adjacent pixel points are arranged in a clockwise/counterclockwise direction around the pixel point. The preset template includes pixel values of three of the eight adjacent pixel points satisfying a third preset condition and the three adjacent pixel points conforming to a first pixel point combination, a second pixel point combination, a third pixel point combination, or a fourth pixel point combination. The first pixel point combination is a combination of the first adjacent point, the fourth adjacent point, and the seventh adjacent point; the second pixel point combination is a combination of the third adjacent point, the fifth adjacent point, and the eighth adjacent point; the third pixel point combination is a combination of the first adjacent point, the third adjacent point, and the sixth adjacent point; and the fourth pixel point combination is a combination of the second adjacent point, the fifth adjacent point, and the seventh adjacent point.

In some embodiments, the third preset condition includes the pixel values being less than or equal to the preset value.

In some embodiments, the method further includes performing multiple traversals on pixel points among the multiple pixel points whose pixel reference information does not satisfy the first preset condition until a fourth preset condition is satisfied.

In some embodiments, the fourth preset condition includes at least one of a ratio of a number of non-target pixel points among the multiple pixel points to a number of the multiple pixel points being greater than or equal to a preset ratio threshold, a number of the traversals reaching a preset number, or a duration of the traversals reaching a preset duration.

In some embodiments, the determining an initial similarity includes: determining whether pixel values of a preset number of pixel points among the multiple plurality of pixel points are the preset value; in response to the pixel values of the preset number of pixel points all being the preset value, not determining the initial similarity of for the preset number of pixel points; in response to a pixel value of at least one pixel point among the preset number of pixel points not being the preset value, determining the initial similarity for the at least one pixel point.

In some embodiments, the preset number is determined based on a number of pixel points that the at least one processor can process in parallel.

One embodiment of the present disclosure provides a system comprising at least one storage device including a set of instructions; and at least one processor in communication with the at least one storage device. When executing the set of instructions, the at least one processor causes the system to perform operations. The operations include obtaining an image to be matched. The image to be matched includes multiple pixel points. The operations include for each of the multiple pixel points, obtaining pixel reference information of the pixel point. The pixel reference information includes first reference information related to a pixel gradient of the pixel point and second reference information related to pixel values of both the pixel point and adjacent pixel points of the pixel point. The operations include determining, based on the pixel reference information, whether the pixel point is a target pixel point, the target pixel point being a pixel point whose pixel value is not a preset value. The operations further include in response to the pixel point being the target pixel point, determining an initial similarity between the target pixel point and a pixel point in a template image; and determining the similarity between the image to be matched and the template image based on at least one initial similarity corresponding to at least one target pixel point.

One embodiment of the present disclosure provides a system comprising a first acquisition module, a second acquisition module, a first determination module, a second determination module, and a third determination module. The image acquisition module is configured to obtain an image to be matched, the image to be matched including multiple pixel points. For each of the multiple pixel points, the second acquisition module is configured to obtain pixel reference information of the pixel point, the pixel reference information including first reference information related to a pixel gradient of the pixel point and second reference information related to pixel values of both the pixel point and its adjacent pixel points of the pixel point. The first determination module is configured to determine, based on the pixel reference information, whether the pixel point is a target pixel point, the target pixel point being a pixel point whose pixel value is not a preset value. The second determination module is configured to determine an initial similarity between the target pixel point and a pixel point in a template image in response to the pixel point being the target pixel point. The third determination module is configured to determine the similarity between the image to be matched and the template image based on at least one initial similarity corresponding to at least one target pixel point.

One embodiment of the present disclosure provides a non-transitory computer readable medium, comprising executable instructions that, when executed by at least one processor, direct the at least one processor to perform the method in the embodiment of the present disclosure.

Additional features may be set forth in part in the description which follows, and in part may become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. The drawings are not to scale. These embodiments are non-limiting exemplary embodiments, in which like reference numerals represent similar structures throughout the several views of the drawings, and wherein:

FIG. 1 is a schematic diagram illustrating an exemplary image processing system according to some embodiments of the present disclosure;

FIG. 2 is a block diagram illustrating an exemplary image processing system according to some embodiments of the present disclosure;

FIG. 3 is a flowchart illustrating an exemplary process for image processing according to some embodiments of the present disclosure;

FIG. 4 is a flowchart illustrating an exemplary process for image processing according to some embodiments of the present disclosure;

FIG. 5 is a flowchart illustrating an exemplary process for image processing according to some embodiments of the present disclosure;

FIG. 6 is a schematic diagram illustrating an exemplary process for image processing according to some embodiments of the present disclosure;

FIG. 7 is a schematic diagram illustrating an exemplary preset template according to some embodiments of the present disclosure; and

FIG. 8 is a schematic diagram illustrating an exemplary preset template according to some embodiments of the present disclosure.

### DETAILED DESCRIPTION

In the following detailed description, numerous specific details are set forth by way of examples in order to provide a thorough understanding of the relevant disclosure. However, it should be apparent to those skilled in the art that the present disclosure may be practiced without such details. In other instances, well-known methods, procedures, systems, components, and/or circuitry have been described at a relatively high level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that the terms “system,” “engine,” “unit,” “module,” and/or “block” used herein are one method to distinguish different components, elements, parts, sections, or assemblies of different levels in ascending order. However, the terms may be displaced by other expressions if they may achieve the same purpose.

It will be understood that when a unit, engine, module, or block is referred to as being “on,” “connected to,” or “coupled to,” another unit, engine, module, or block, it may be directly on, connected or coupled to, or communicate with the other unit, engine, module, or block, or an intervening unit, engine, module, or block may be present unless the context clearly indicates otherwise. As used herein, the term “and/or” includes any or all combinations of one or more of the associated listed items.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

Template matching typically employs edge-feature-based matching. The edge-feature-based matching involves calculating edge information of an image to be matched and a template image, and then performing edge matching based on the edge information to obtain a region where the edge information of an object in the image to be matched most closely matches the edge information of an object in the template image.

Shape-based template matching is a type of edge-feature-based matching which usually involves extracting edge features (also referred to as edge feature vectors) of both the image to be matched and the template image, and then calculating a similarity of gradient vectors between the template image and the image to be matched based on the edge features. Due to the complexity of algorithms used in the similarity calculation process, the computational load is significant. For example, during the similarity calculation process, for a two-dimensional image, four dimensions need to be considered simultaneously including angle, scale, and X and Y directions in a two-dimensional plane coordinate system, which places high demands on the computational performance of the processing device.

The present disclosure provides a method and a system for determining a similarity. The method includes obtaining an image to be matched, the image to be matched including multiple pixel points. The method includes for each of the multiple pixel points, obtaining pixel reference information of the pixel point. The pixel reference information includes first reference information related to a pixel gradient of the pixel point and second reference information related to pixel values of both the pixel point and adjacent pixel points of the pixel point. The method includes determining, based on the pixel reference information, whether the pixel point is a target pixel point, the target pixel point being a pixel point whose pixel value is not a preset value. The method further includes in response to the pixel point being the target pixel point, determining an initial similarity between the target pixel point and a pixel point in a template image and determining the similarity between the image to be matched and the template image based on at least one initial similarity corresponding to at least one target pixel point.

According to the embodiments of the present disclosure, the pixel points in the image to be matched may be filtered based on the pixel gradients and the pixel values. A similarity calculation is only performed on the filtered pixel points (i.e., target pixel points) in the image to be matched and pixel points in the template image, which reduces the number of pixel points involved in the similarity calculation, thereby decreasing computational load and lowering the computational performance requirements for processing equipment. As a result, image processing efficiency is improved.

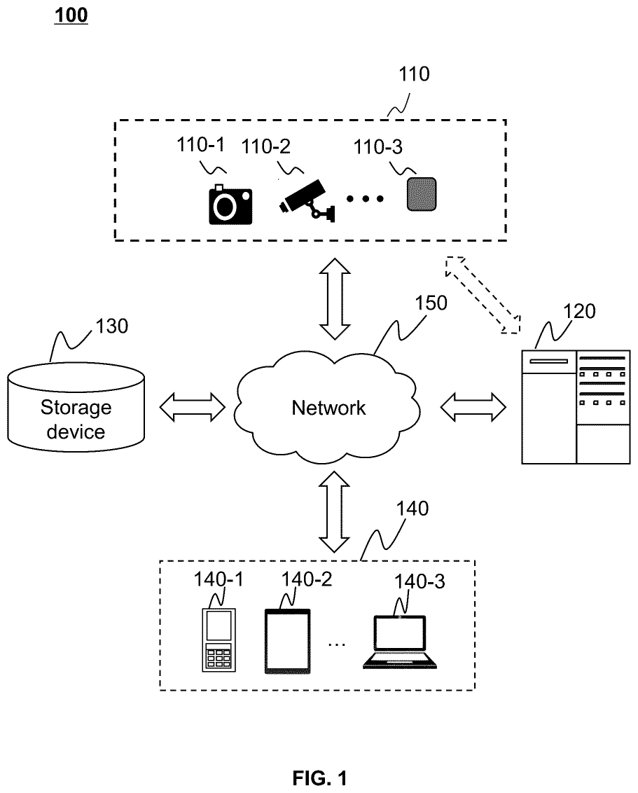

FIG. 1 is a schematic diagram illustrating an exemplary image processing system 100 according to some embodiments of the present disclosure. As shown in FIG. 1, the image processing system 100 may include an image acquisition device 110, a processing device 120, a storage device 130, a terminal 140, and a network 150.

The image acquisition device 110 may be configured to acquire one or more images (the term “image” herein refers to a single image or a frame of a video). In some embodiments, the image acquisition device 110 may include a camera 110-1, a video recorder 110-2, an image sensor 110-3, etc. The camera 110-1 may include a gun camera, a dome camera, an integrated camera, a monocular camera, a binocular camera, a multi-view camera, or the like, or any combination thereof. The video recorder 110-2 may include a PC Digital Video Recorder (DVR), an embedded DVR, or the like, or any combination thereof. The image sensor 110-3 may include a Charge Coupled Device (CCD) image sensor, a Complementary Metal Oxide Semiconductor (CMOS) image sensor, or the like, or any combination thereof. In some embodiments, the image acquisition device 110 may include a plurality of components each of which can acquire an image. For example, the image acquisition device 110 may include a plurality of sub-cameras that can capture images or videos simultaneously. In some embodiments, the image acquisition device 110 may transmit the acquired image to one or more components (e.g., the processing device 120, the storage device 130, the terminal 140) of the image processing system 100 via the network 150.

The processing device 120 may process information and/or data relating to the image processing to perform one or more functions described in the present disclosure. For example, the processing device 120 may obtain the image to be matched. The image to be matched may include multiple pixel points. For each of the multiple pixel points, the processing device 120 may obtain pixel reference information of the pixel point. The pixel reference information may include first reference information related to a pixel gradient of the pixel point and second reference information related to pixel values of the pixel point and adjacent pixel points of the pixel point. The processing device 120 may determine, based on the pixel reference information, whether the pixel point is a target pixel point. The target pixel point may be a pixel point whose pixel value is not a preset value. The processing device 120 may determine, in response to the pixel point being the target pixel point, an initial similarity between the target pixel point and a pixel point in a template image and determine the similarity between the image to be matched and the template image based on at least one initial similarity corresponding to at least one target pixel point.

The processing device 120 may be a single server or a server group. The server group may be centralized, or distributed (e.g., the processing device 120 may be a distributed system). In some embodiments, the processing device 120 may be local or remote. For example, the processing device 120 may access information and/or data stored in the image acquisition device 110 and/or the storage device 130 via the network 150. As another example, the processing device 120 may be directly connected to the image acquisition device 110 and/or the storage device 130 to access stored information and/or data. In some embodiments, the processing device 120 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the processing device 120 may include one or more processors (e.g., single-core processor(s) or multi-core processor(s)). Merely by way of example, the processing device 120 may include a central processing unit (CPU), an application-specific integrated circuit (ASIC), an application-specific instruction-set processor (ASIP), a graphics processing unit (GPU), a physics processing unit (PPU), a digital signal processor (DSP), a field-programmable gate array (FPGA), a programmable logic device (PLD), a controller, a microcontroller unit, a reduced instruction-set computer (RISC), a microprocessor, or the like, or any combination thereof.

The storage device 130 may store data and/or instructions. The data and/or instructions may be obtained from, for example, the processing device 120, the image acquisition device 110, and/or any other component of the image processing system 100. For example, the storage device 130 may store data and/or information such as images collected by the image acquisition device 110. As another example, the storage device 130 may store data and/or information processed by the processing device 120, such as the similarity of different images. In some embodiments, the storage device 130 may store data and/or instructions that the processing device 120 may execute or use to perform exemplary methods described in the present disclosure. In some embodiments, the storage device 130 may include a mass storage device, a removable storage device, a volatile read-and-write memory, a read-only memory (ROM), or the like, or any combination thereof. In some embodiments, the storage device 130 may be implemented on a cloud platform. In some embodiments, the storage device 130 may be part of the processing device 120 and/or the image acquisition device 110.

The terminal 140 may interact with a user. The user may issue an operational instruction to the image acquisition device 110 through the terminal 140, enabling the image acquisition device 110 to complete a specific operation, such as capturing an image, etc. In some embodiments, the terminal 140 may send the instruction to the processing device 120 to execute the exemplary method described in the present disclosure. In some embodiments, the terminal 140 may receive a determination result of image similarity from the processing device 120, and the user may perform further processing based on the result. In some embodiments, the terminal 140 may be one or any combination of other devices with input and/or output capabilities, such as a mobile device 140-1, a tablet computer 140-2, a laptop computer 140-3, a desktop computer, etc.

The network 150 may include any suitable network that can facilitate the exchange of information and/or data for the image processing system 100. In some embodiments, one or more components (e.g., the processing device 120, the image acquisition device 110) of the image processing system 100 may communicate information and/or data with one or more other components of the image processing system 100 via the network 120. For example, the processing device 120 may obtain the image to be matched from the image acquisition device 110 via the network 150. In some embodiments, the network 150 may be or include a wired network, a wireless network (e.g., an 802.11 network, a Wi-Fi network), etc.

It should be noted that the above description is merely provided for the purposes of illustration, and is not intended to limit the scope of the present disclosure. For persons having ordinary skills in the art, multiple variations and modifications may be made under the teachings of the present disclosure. In some embodiments, the image processing system 100 may include one or more additional components and/or one or more components of the image processing system 100 described above may be omitted. Additionally or alternatively, two or more components of the image processing system 100 may be integrated into a single component. For example, the processing device 120 may be integrated into the image acquisition device 110. A component of the image processing system 100 may be implemented on two or more sub-components. However, those variations and modifications do not depart from the scope of the present disclosure.

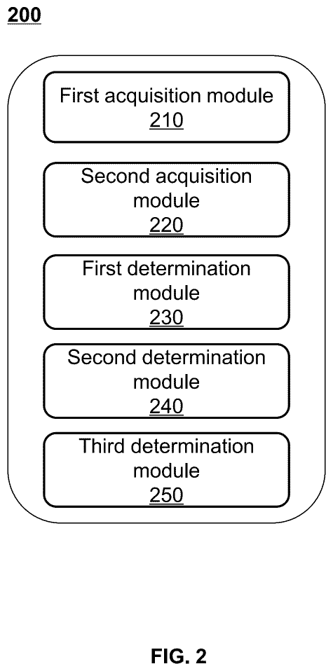

FIG. 2 is a block diagram illustrating an exemplary image processing system 200 according to some embodiments of the present disclosure. As shown in FIG. 2, the image processing system 200 for processing an image includes a first acquisition module 210, a second acquisition module 220, a first determination module 230, a second determination module 240, and a third determination module 250. In some embodiments, the modules of the image processing system 200 may be implemented by the processing device 120.

The first acquisition module 210 may be configured to obtain an image to be matched. The image to be matched may include multiple pixel points. More descriptions of the obtaining of the image to be matched may be found elsewhere in the present disclosure (e.g., operations 310 and the descriptions thereof).

The second acquisition module 220 may be configured to obtain, for each of the multiple pixel points, pixel reference information of the pixel point. The pixel reference information may include first reference information and second reference information. The first reference information is related to a pixel gradient of the pixel point, and the second reference information is related to pixel values of the pixel point and adjacent pixel points of the pixel point. More descriptions of the obtaining of the pixel reference information may be found elsewhere in the present disclosure (e.g., operations 320 and the descriptions thereof).

The first determination module 230 may be configured to determine whether the pixel point is a target pixel point based on the pixel reference information. The target pixel point is a pixel point whose pixel value is not a preset value. More descriptions of the determination of whether the pixel point is a target pixel point may be found elsewhere in the present disclosure (e.g., operations 330 and the descriptions thereof).

The second determination module 240 may be configured to determine, in response to the pixel point being the target pixel point, an initial similarity between the target pixel point and a pixel point in a template image. More descriptions of the determination of the initial similarity may be found elsewhere in the present disclosure (e.g., operations 340 and the descriptions thereof).

The third determination module 250 may be configured to determine the similarity between the image to be matched and the template image based on at least one initial similarity corresponding to at least one target pixel point. More descriptions of the determination of the similarity between the image to be matched and the template image may be found elsewhere in the present disclosure (e.g., operations 350 and the descriptions thereof).

It should be noted that the above descriptions of the image processing system 200 are provided for the purposes of illustration, and are not intended to limit the scope of the present disclosure. For persons having ordinary skills in the art, various modifications and changes in the forms and details of the application of the above system may occur without departing from the principles of the present disclosure. In some embodiments, the image processing system 200 may include one or more other modules and/or one or more modules described above may be omitted. Additionally or alternatively, two or more modules may be integrated into a single module and/or a module may be divided into two or more units. For example, the first acquisition module 210 and the second acquisition module 220 may be integrated into a single module that can perform the functions of the first acquisition module 210 and the second acquisition module 220. As another example, the first determination module 230, the second determination module 240, and the third determination module 250 may be integrated into a single module that can perform the functions of the first determination module 230, the second determination module 240, and the third determination module 250. However, those variations and modifications also fall within the scope of the present disclosure.

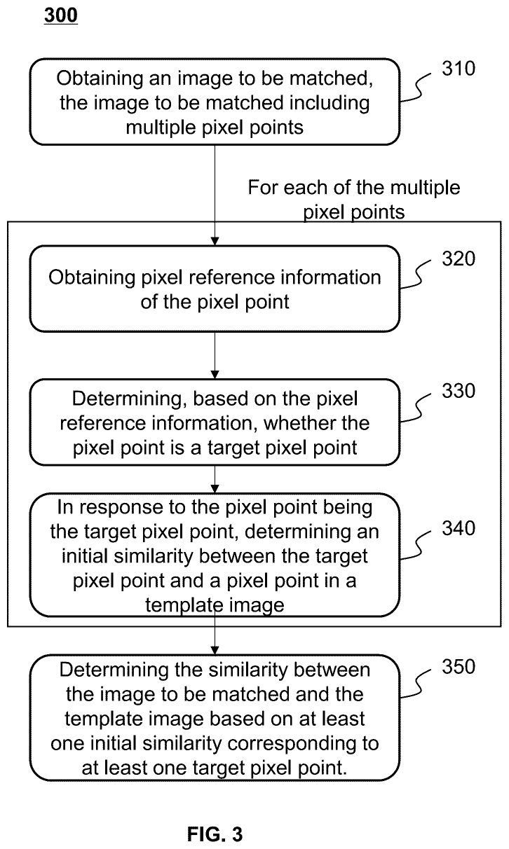

FIG. 3 is a flowchart illustrating an exemplary process for image processing according to some embodiments of the present disclosure. In some embodiments, process 300 may be executed by the image processing system 100 and/or the image processing system 200. For example, process 300 may be implemented as a set of instructions (e.g., an application) stored in a storage device (e.g., the storage device 130 illustrated in FIG. 1). In some embodiments, the processing device 120 of the image processing system 100 and/or one or more modules of the image processing system 200 may execute the set of instructions and may accordingly be directed to perform the process 300.

In 310, an image to be matched may be obtained. In some embodiments, operation 310 may be performed by the first acquisition module 210 shown in FIG. 2.

The image to be matched refers to an image that needs to be template matched. The image to be matched may include various types of images, such as a two-dimensional image, a three-dimensional image, etc. For illustration purposes, the following descriptions are provided with reference to the two-dimensional image, and this is not intended to be limiting. In some embodiments, the image to be matched may be obtained through an image acquisition device (e.g., the image acquisition device 110). For example, the image to be matched may be a video frame extracted from a video captured by the image acquisition device that meets certain quality requirements (e.g., image brightness and clarity). As another example, the image to be matched may be a single image frame captured by the image acquisition device. In some embodiments, the image to be matched may be obtained through other means, such as retrieving it from a storage device (e.g., the storage device 130). In some embodiments, the image to be matched may be a complete image or at least a part of the complete image. For instance, the image to be matched may be a sub-image obtained by segmenting the complete image.

In some embodiments, the image to be matched may include an object to be matched and a background image, etc. The object to be matched is an object that needs to be matched with a target object in the template image, such as an animal, a human, a vehicle, etc. Pixel points in the background image are considered noise points. In conventional template matching, the calculation of similarity between the pixel points in the background image and pixel points in the template image is included, which is unnecessary and increases the computational load, thereby reducing the efficiency of template matching.

The image to be matched may include multiple pixel points, and the processing device 120 may perform the operations 320-340 on each of the multiple pixel points.

In 320, for each of the multiple pixel points, pixel reference information of the pixel point may be obtained. In some embodiments, operation 320 may be performed by the second acquisition module 220.

The pixel reference information refers to information related to a pixel point feature. For example, the information related to the pixel point feature includes color, brightness, grayscale, and gradient of the pixel point. In some embodiments, the processing device 120 may process the pixel point through a preset image processing algorithm or a machine learning model to obtain the pixel reference information of the pixel point. In some embodiments, the processing device 120 may store the obtained pixel reference information in a storage device (e.g., the storage device 130) for use in subsequent operations.

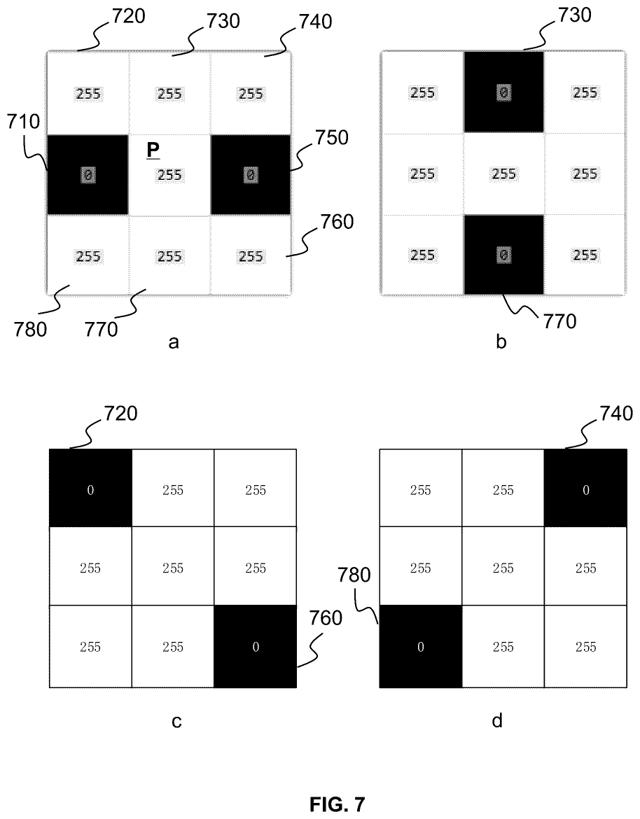

The pixel reference information may include first reference information and second reference information. The first reference information is related to the pixel gradient of the pixel point, and the second reference information is related to pixel values of both the pixel point and adjacent pixel points of the pixel point. The adjacent pixel points of the pixel point refer to pixel points adjacent to the pixel point. Two pixel points are adjacent if there are no other pixel points separating them. For example, as shown in FIG. 7, the adjacent pixel points of a pixel point P may include eight pixel points 710-780 located around the pixel point P and centered on the pixel point P.

The first reference information may include a gradient magnitude of the pixel point. The processing device 120 may obtain a pixel gradient of the pixel point based on pixel values of the pixel point and the adjacent pixel points of the pixel point, and calculate the gradient magnitude of the pixel point based on the pixel gradient. The pixel gradient of the pixel point represents a magnitude of change from the pixel value of the pixel point to the pixel values of the adjacent pixel points of the pixel point. For pixel points located at an edge of an object in the image to be matched and an edge of the image to be matched itself, there is a significant change in pixel values, resulting in larger gradient values. Conversely, smooth regions of the image to be matched exhibit smaller changes in pixel values, leading to smaller gradient values. In some embodiments, the pixel gradient of the pixel point may be determined based on a difference in pixel values between its left and right adjacent pixel points or its upper and lower adjacent pixel points. A larger gradient value indicates a greater difference in pixel values. The larger this difference is, the higher the likelihood that the pixel point belongs to the edge of the object in the image to be matched or the image to be matched itself. Therefore, obtaining the pixel gradient of the pixel point in the image to be matched may be considered as extracting contours of the object in the image to be matched and the image to be matched itself, essentially performing edge detection on the image to be matched.

In some embodiments, the processing device 120 may represent the pixel gradient of the pixel point as (mₓ, m_{y}), wherein mₓ is a gradient of the pixel point along an x-direction and m_{y} is a gradient of the pixel point along a y-direction. The gradient magnitude of the pixel point may then be calculated as

$$\sqrt{{m}_{x}^{2} + {m}_{y}^{2}} .$$

In some embodiments, the gradient magnitude may take other functional forms of mₓ and m_{y}, which are not limited in the present disclosure.

The second reference information may include the pixel values of the pixel point and the adjacent pixel points of the pixel point. The pixel values may include values that reflect the color or brightness of the pixel points. For example, the pixel values may include a RGB value, a grayscale value, etc. For illustration purposes, the following descriptions are provided with reference to the grayscale value, and this is not intended to be limiting. By way of example only, the grayscale value is in a range from 0 to 255.

In 330, for the each of the multiple pixel points, whether the pixel point is a target pixel point may be determined based on the pixel reference information of the pixel point. In some embodiments, operation 330 may be performed by the first determination module 230.

The target pixel point refers to a pixel point in the image to be matched that needs to participate in the similarity calculation. For example, the target pixel point may include an edge point of the object in the image to be matched, an edge point of the image to be matched, etc. In some embodiments, the processing device 120 may determine whether the pixel reference information of the pixel point meets a preset condition (e.g., a first preset condition, a second preset condition). If the pixel reference information of the pixel point meets the preset condition, the pixel point is determined not to be the target pixel point, and its pixel value is set to a preset value. In some embodiments, the target pixel point may be a pixel point whose pixel value is not the preset value.

In some embodiments, the preset value may be 0 or a smaller pixel value, such as 3, 5, or any other value not exceeding 10. The preset value may be determined in various ways. For example, the preset value may be determined based on experience. As another example, the preset value may be determined based on a statistical feature of the pixel values of the multiple pixel points in the image to be matched. By way of example only, the statistical feature may include at least one of a mean, a range, and a variance of the pixel values of the multiple pixel points in the image to be matched. In some embodiments, the processing device 120 may determine the preset value based on the statistical feature of the pixel values of the multiple pixel points in the image to be matched through various methods. For example, the processing device 120 may construct a lookup table for the preset value based on the statistical feature and corresponding reference preset value. The reference preset value refers to a preset value that provides the most accurate and fastest matching when using. As another example, the processing device 120 may determine the preset value through a machine learning model. An input of the machine learning model may be the statistical feature, and an output is the preset value. The machine learning model may include a logistic regression model, a random forest model, or a support vector machine (SVM) model, etc. More description of determining whether the pixel point is a target pixel point based on the pixel reference information may be found elsewhere in the present disclosure (e.g., processes 400 and 500, and the descriptions thereof).

According to the embodiments of the present disclosure, by screening out some pixel points (for example, pixel points whose pixel values are the preset value) in the image to be matched through a preset condition, the number of pixel points participating in subsequent similarity determinations is reduced, thereby decreasing the computational load and improving the efficiency of template matching.

In 340, for the each of the multiple pixel points, in response to the pixel point being the target pixel point, an initial similarity between the target pixel point and a pixel point in a template image may be determined. In some embodiments, operation 340 may be executed by the second determination module 240.

The template image is an image containing a target object. The target object is an object that the user hopes the image to be matched to match. The target object may include various types, such as an animal, a human body, a vehicle, etc. In some embodiments, the template image may contain at least a part of the target object. For example, if the target object is a vehicle license plate, the template image includes the vehicle license plate or a portion of it. In some embodiments, the processing device 120 may obtain the template image from the user. For example, the processing device 120 may obtain the template image through user input or import. In some embodiments, the processing device 120 may obtain the template image in other ways. For example, the processing device 120 may retrieve the template image from a storage device (e.g., the storage device 130). In some embodiments, after the pixel point in the image to be matched is identified as the target pixel point, the processing device 120 may determine the initial similarity between the target pixel point and the pixel point in the template image. In some embodiments, the size and the shape of the image to be matched and the template image may be the same or different. The processing device 120 may perform multiple coordinate transformations on the template image. After each coordinate transformation, the initial similarity between the target pixel point in the image to be matched and the pixel point in the template image is calculated.

In some embodiments, the processing device 120 may process a preset number of pixel points in the image to be matched at a time. For example, the processing device 120 may determine whether pixel values of the preset number of pixel points among the multiple pixel points in the image to be matched are the preset value. In response to the pixel values of the preset number of pixel points all being the preset value (which means these pixel points are not target pixel points), the processing device 120 may not determine the initial similarity for the preset number of pixel points. For example, the processing device 120 may record the initial similarity for the preset number of pixel points as 0 or null. In response to a pixel value of at least one pixel point among the preset number of pixel points not being the preset value (indicating the presence of target pixel points among the preset number), the processing device 120 may determine the initial similarity for the at least one pixel point. That is, the processing device 120 may calculate the initial similarity only for at least one target pixel point among the preset number of pixel points, while for non-target pixel points among the preset number of pixel points, the processing device 120 may skip calculate the initial similarity and record their initial similarity as 0 or null. The above process of determining the initial similarity may be performed iteratively until all pixel points in the image to be matched are processed.

According to the embodiments of the present disclosure, by determining whether the pixel value of the pixel point is the preset value, it is decided whether to proceed with subsequent initial similarity determination for that pixel point, which reduces the number of pixel points involved in the initial similarity calculation, thereby decreasing computational load and improving template matching efficiency.

In some embodiments, the preset number is determined based on the number of pixel points that the processing device 120 can process in parallel (also referred to as parallel processing capability). For example, when using the AVX2 instruction set for processing, the processing device 120 may simultaneously process 16 pixel points at a time. As another example, multi-threaded parallel processing may be performed using opencv. Furthermore, the processing device 120 may use multiple processors for parallel processing, in which case the parallel processing capability of the processing device 120 is the sum of the processing capabilities of these processors. Alternatively, the processing device 120 may distribute tasks across multiple processing nodes for distributed parallel processing of pixel points, where the parallel processing capability of the processing device 120 is the sum of the processing capabilities of the distributed nodes.

According to the embodiments of the present disclosure, the number of pixel points to process each time is determined based on the parallel processing capability of the processing device, which fully utilizes the device's capabilities, reduces computational resource waste, speeds up processing, and improves template matching efficiency.

In some embodiments, after filtering out non-target pixel points in the image to be matched, the processing device 120 may select some of the remaining pixel points as target pixel points. For example, the processing device 120 may randomly sample some pixel points from the remaining pixel points using complete random sampling. As another example, the processing device 120 may sample some pixel points from the remaining pixel points according to a preset sampling rule. The preset sampling rule may include setting more sampling points closer to the center of the image to be matched and fewer sampling points further away from the center of the image to be matched. By way of example only, a function for setting the sampling points according to the preset sampling rule may be a Gaussian function.

Feature points in the template image refer to pixel points in the template image that are involved in the similarity calculation. In some embodiments, the feature points in the template image may be determined through various methods.

In some embodiments, the feature points in the template image may include edge points. For example, the edge points may include edge pixel points of the target object in the template image, edge pixel points of the template image itself, etc. The processing device 120 may determine the edge points in the template image through a method such as an edge detection algorithm or a machine learning model, and designate the edge points as the feature points in the template image.

In some embodiments, the processing device 120 may select some pixel points in the template image to participate in the similarity calculation according to a preset rule. The preset rule may include random sampling, sampling according to an arrangement rule, etc. The random sampling may be similar to the random sampling of the non-target pixel points in the image to be matched. The sampling according to an arrangement rule may be done by row or column. For example, the sampling according to an arrangement rule may include sampling 10 pixel points from each row of pixel points. In some embodiments, the feature points in the template image may be an intersection of the edge points and the pixel points selected according to the preset rule.

According to the embodiments of the present disclosure, some pixel points in the image to be matched are filtered out based on the preset condition. On this basis, further filtering of pixel points in both the image to be matched and the template image is done through the random sampling and/or the preset rule, thereby reducing the number of pixel points involved in the similarity calculation, decreasing computational load, and further improving template matching efficiency.

In some embodiments, the processing device 120 may determine the initial similarity between the target pixel point in the image to be matched and the pixel point in the template image using various similarity determination methods. For example, the similarity determination methods include calculating the cosine angle, calculating Euclidean distance, and calculating Manhattan distance, etc.

In some embodiments, the pixel point in the template image that participates in the similarity calculation along with the target pixel point is a pixel point in the template image corresponding to the target pixel point. The coordinates of the pixel point in the template image are the same as the coordinates of the target pixel point in the image to be matched. It should be noted that the target pixel point and the corresponding pixel point in the template image that participate in the similarity calculation may be referred to as a set of pixel points.

Taking the method for determining a similarity by calculating the cosine angle as an example, the following explains how to determine the initial similarity between the target pixel point and the pixel point in the template image. The processing device 120 may normalize a gradient of the pixel point in the template image according to the following formula (1) to convert the gradient into a gradient vector with a modulus length of unit length:

$$A = \frac{( {m}_{x} , {m}_{y} )}{\sqrt{{m}_{x}^{2} + {m}_{y}^{2}}} , \qquad ( 1 )$$

where the pixel point is a feature point in the template image; A represents the gradient vector of the pixel point; mₓ is the gradient of the pixel point along the x-direction; m_{y} is the gradient of the target pixel point along the y-direction; and

$$\sqrt{{m}_{x}^{2} + {m}_{y}^{2}}$$

is the gradient magnitude of the pixel point.

Furthermore, the processing device 120 may normalize the gradient of a pixel point in the image to be matched corresponding to the feature point in the template image in a similar manner as formula (1), and the gradient vector obtained after processing is denoted as B. Then, the processing device 120 may determine the initial similarity between the target pixel point and the pixel point in the template image according to the following formula (2):

$$similarity = cos ( θ ) = \frac{A \cdot B}{‖ A ‖ ‖ B ‖} = \frac{{\sum }_{i = 1}^{n} {A}_{i} {B}_{i}}{\sqrt{{\sum }_{i = 1}^{n} {A}_{i}^{2}} \sqrt{{\sum }_{i = 1}^{n} {B}_{i}^{2}}} , \qquad ( 2 )$$

where similarity represents the initial similarity, θ represents an angle between A and B. The smaller the angle θ is, the higher the similarity will be. When θ is 0, similarity is 1, indicating extremely high similarity. i represents a serial number of the feature points in the template image, and n represents the number of the feature points in the template image. Aᵢ represents the gradient vector of an i-th feature point in the template image, while Bᵢ represents the gradient vector of a pixel point in the image to be matched that corresponds to the i-th feature point in the template image. For non-target pixel points in the image to be matched, their gradient vectors are 0, i.e., AᵢBᵢ=0. Since the gradient vector of the non-target pixel points is 0, in some embodiments, when calculating the initial similarity using formula (2), the non-target pixel points and their corresponding feature points in the template image may be excluded, significantly reducing the computational complexity.

In some embodiments, the initial similarity calculated in formula (2) corresponds to a specific set of parameters. The specific set of parameters include an angle, a scale, and a position related to the template image and the target image. The ranges of values fo the r angle, the scale, and the position may be preset. For example, a range of the angle may be −180° to 180°, a range of the scale may be 0.5 to 5 (no unit, representing a multiplier), and a range of the position may be the resolution of the template image. The processing device 120 may assign a value to each parameter within the preset ranges of angle, scale, and position, and then combine them into a set of parameters. Using formula (2), the initial similarity corresponding to this set of parameters may be obtained. After traversing all values within the preset ranges, multiple initial similarities are obtained. By way of example only, the processing device 120 may perform coordinate transformations on feature points in the template image based on a set of traversal parameters to obtain new coordinates. Then, the initial similarity is calculated based on the new coordinates. The coordinate transformations may include a rotation (based on an angle in the set of traversal parameters), a scaling (based on a scale in the set of traversal parameters), and a translation (based on a position in the set of traversal parameters). The new coordinates of the feature points in the template image after coordinate transformation may be expressed as formula (3) below:

$$[ \begin{matrix}{x}^{′} \\ {y}^{′} \\ 1\end{matrix} ] = [ \begin{matrix}1 & 0 & {t}_{x} \\ 0 & 1 & {t}_{y} \\ 0 & 0 & 1\end{matrix} ] [ \begin{matrix}{s}_{x} cos ( β ) & - {s}_{y} sin ( β ) & 0 \\ {s}_{x} sin ( β ) & {s}_{y} cos ( β ) & 0 \\ 0 & 0 & 1\end{matrix} ] [ \begin{matrix}x \\ y \\ 1\end{matrix} ] , \qquad ( 3 )$$

where x and y are the original coordinates of the feature points in the template image before the coordinate transformation, and x′ and y′ are the coordinates of the feature points in the template image after the coordinate transformation; tₓ and t_{y} are the scaling values (i.e., the scale in the traversal parameters) in the coordinate transformation; sₓ and s_{y} are the translation values (i.e., the position in the traversal parameters) in the coordinate transformation; β is the rotation value (i.e., the angle in the traversal parameters) in the coordinate transformation. After each coordinate transformation, the processing device 120 may calculate initial similarities between the feature points in the template image and the corresponding pixel points in the image to be matched to obtain at least one initial similarity. After multiple coordinate transformations, the set of all obtained initial similarities is taken as the final initial similarity.

It can be seen that calculating the initial similarity by computing the cosine angle involves a tedious calculation process and high algorithm complexity. According to the embodiments of the present disclosure, pixel points are filtered through the preset condition related to the pixel reference information, and the initial similarity calculation is only performed on the filtered target pixel points, which reduces the number of pixel points involved in the similarity calculation, greatly reduces the amount of the similarity calculation, decreases the time consumed by calculation, and increases the speed of template matching.

In 350, the similarity between the image to be matched and the template image may be determined based on at least one initial similarity corresponding to at least one target pixel point. In some embodiments, operation 350 may be executed by the third determination module 250.

After obtaining the initial similarities between all target pixel points in the image to be matched and the corresponding pixel points in the template image, the processing device 120 may determine the similarity between the image to be matched and the template image based on these initial similarities. The higher the similarity is, the higher the match between the image to be matched and the template image is. By way of example only, when a value of the initial similarities is in a range from 0 to 1, a value of the similarity between the image to be matched and the template image may also be in a range from 0 to 1. In this case, when the similarity between the matched image and the template image is greater than or equal to a preset value (e.g., 0.95, 0.98, etc.), it may be considered that the image to be matched matches the template image.

In some embodiments, the processing device 120 may further process these initial similarities and use the processing results as the similarity between the image to be matched and the template image. For example, the processing includes maximizing, etc. Specifically, the processing device 120 may take the maximum value from the multiple initial similarities obtained in operation 340, and use this maximum value as the similarity between the target image and the template image.

In some embodiments, the calculated similarity between the image to be matched and the template image may have the same value range as the initial similarities. For example, the value range is a range from 0 to 1.

In some embodiments, the processing device 120 may use the similarity between the image to be matched and the template image obtained based on the initial similarities as a first similarity. The processing device 120 may determine a second similarity based on the pixel values of multiple sets of pixel points in the image to be matched and the template image. The first and second similarities are weighted and summed, and the result is used as the final similarity between the image to be matched and the template image. The weight of the first similarity is greater than the weight of the second similarity. The second similarity is determined as follows. The processing device 120 may construct a first feature vector based on the pixel values of all target pixel points. Elements in the first feature vector are the pixel values of the target pixel points. Then, the processing device 120 may construct a second feature vector based on the pixel points in the template image corresponding to the target pixel points. Elements in the second feature vector are the pixel values of these pixel points in the template image. Further, the processing device 120 may determine a similarity between the first feature vector and the second feature vector as the second similarity. The manner for calculating the similarity between the first feature vector and the second feature vector may be similar to formula (2).

In some embodiments, the processing device 120 may determine a third similarity based on the initial similarities of a portion of the target pixel points in the image to be matched. For example, the processing device 120 may determine the third similarity based on the initial similarities of key points among the target pixel points in the image to be matched. The key points may be pixel points with an initial similarity greater than or equal to a set value (e.g., the set value is determined based on experience).

In some embodiments, if the third similarity is less than the preset value (e.g., 0.95, 0.98, etc.), it may be considered that the image to be matched does not match the template image. If the third similarity is greater than or equal to the preset value, the processing device 120 may determine a fourth similarity based on initial similarities of the remaining target pixel points or all target pixel points in the image to be matched, and designate the fourth similarity as the similarity between the image to be matched and the template image.

By way of example only, the processing device 120 may divide the target pixel points in the image to be matched into discrete points and non-discrete points. The discrete points are target pixel points that are relatively far apart from each other in the image to be matched (e.g., pixel points at the corners of the image to be matched). The non-discrete points are other target pixel points in the image to be matched besides the discrete points. The processing device 120 may first determine the third similarity based on the discrete points. If the third similarity is less than the preset value (e.g., 0.95, 0.98, etc.), it is considered that the image to be matched does not match the template image; otherwise, the processing device 120 may determine the fourth similarity based on the non-discrete points, and determine whether the image to be matched matches the template image based on the fourth similarity.

As another example, the processing device 120 may determine a sub-image of a preset size (e.g., 3 pixel points*3 pixel points, 5 pixel points*5 pixel points, etc.) containing feature points (e.g., edge points of the template image) in the template image as a matching template. The processing device 120 may determine a fifth similarity between the matching template and a corresponding sub-image in the image to be matched. If the fifth similarity is less than the preset value (e.g., 0.95, 0.98, etc.), it is considered that the image to be matched does not match the template image; otherwise, the processing device 120 may determine a sixth similarity based on the initial similarities of all target pixel points and determine whether the image to be matched matches the template image based on the sixth similarity.

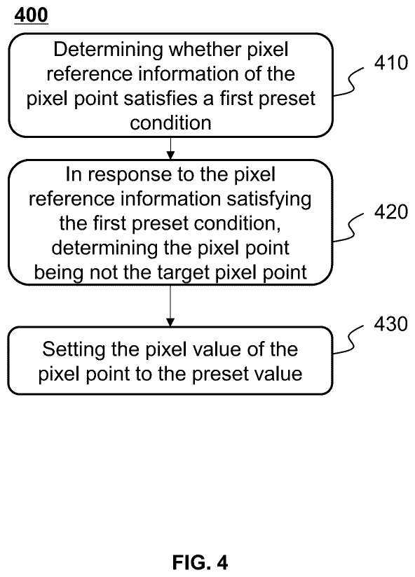

FIG. 4 is a flowchart illustrating an exemplary process for image processing according to some embodiments of the present disclosure. In some embodiments, at least part of the process 400 may be performed to achieve at least part of operation 330 as described in connection with FIG. 3. For example, the processing device 120 or the first determination module 230 may determine whether a pixel point in the image to be matched is a target pixel point by executing at least part of the process 400.

In 410, for each of the multiple pixel points in the image to be matched, whether pixel reference information of the pixel point satisfies a first preset condition may be determined.

The first preset condition may be set based on a comparison between the first reference information and a preset threshold. In some embodiments, the first reference information may be a gradient magnitude of the pixel point, and the first preset condition may be that the gradient magnitude is less than the preset threshold. Satisfying the first preset condition means that there is a high possibility that the pixel point is not an edge point of the object in the image to be matched or an edge point of the image to be matched itself.

The preset threshold may be determined in various ways. For example, the preset threshold may be determined based on experience, requirements, preset rules, etc.

In some embodiments, the preset threshold may be determined based on a candidate feature of the image to be matched. The candidate feature may include a contrast and a gradient magnitude statistical feature of the image to be matched. By way of example only, the gradient magnitude statistical feature may include average, range, and variance of gradient magnitudes of the multiple pixel points in the image to be matched. In some embodiments of the present disclosure, the setting of the preset threshold is related to the gradient magnitude statistical feature of the image to be matched, thereby reducing the possibility of edge pixel points in the image to be matched being filtered out and improving the accuracy of similarity calculation between the image to be matched and the template image.

When the contrast of the image to be matched is low, it is difficult to distinguish the object in the image to be matched from surrounding information. If the preset threshold is set too high, some pixel points on the object may be filtered out, thereby introducing errors in the similarity calculation between the image to be matched and the template image. Therefore, in some embodiments of the present disclosure, the setting of the preset threshold is related to the contrast of the image to be matched, thereby reducing the possibility of pixel points on the object in the image to be matched being filtered out and improving the accuracy of similarity calculation between the image to be matched and the template image. In some embodiments, the higher the contrast of the image to be matched is, the larger the preset threshold may be; the lower the contrast is, the smaller the preset threshold is.

In some embodiments, the way the processing device 120 determines the preset threshold may be similar to the way the preset value is determined in operation 330. For example, a lookup table for the preset threshold may be constructed based on the contrast, the gradient magnitude statistical feature, and the corresponding reference preset threshold, and the preset threshold may be determined according to the lookup table. Another example is to input the contrast and the gradient magnitude statistical feature of the image to be matched into a machine learning model to obtain the output preset threshold.

In some embodiments, the candidate feature may further include a contrast of a candidate region in the image to be matched. The candidate region refers to a region in the image to be matched that may include the object.

In some embodiments, the candidate feature may correspond to multiple candidate regions in the image to be matched. At least one of the shapes or sizes of the multiple candidate regions may be different. By way of example only, the candidate regions may be determined in the following way: selecting a representative feature (such as a circle, a corner, or a line segment, etc.) of the target object in the template image; performing edge detection on the image to be matched, and obtaining a matching feature similar in shape to the representative feature from extracted edges; determining a region within the smallest rectangle containing the matching feature as a candidate region. As another example, based on the previous example, any shape and size of the region in the image to be matched may be determined as a candidate region, as long as it contains the matching feature. In some embodiments, the contrast of the candidate region may be determined based on a weighted calculation of the contrasts of multiple candidate regions. Specifically, the contrasts of the multiple candidate regions may be weighted and summed, and the weighted sum is determined as the contrast of the candidate region.

According to the embodiments of the present disclosure, the contrast of the candidate region is determined based on the contrasts of the multiple regions, which provides more precise contrast measurement, thereby improving the accuracy of the preset threshold and enhancing the accuracy of similarity calculation between the image to be matched and the template image.

In some embodiments, the processing device 120 may determine the preset threshold based on a processing speed requirement and the gradient magnitude statistical feature of the image to be matched. The higher the processing speed requirement is, the faster the matching speed required is, and the higher the preset threshold may be (it cannot exceed an upper limit). By setting the preset threshold according to the processing speed requirement, as many pixel points as possible may be filtered out when the processing speed requirement is high, thereby ensuring the processing speed requirement and improving template matching efficiency; when the processing speed requirement is not high, more pixel points are retained for similarity calculation, improving template matching accuracy.

In some embodiments, the processing device 120 may use a pyramid model for template matching between the image to be matched and the template image. When setting the preset threshold, the higher the pyramid level is, the smaller the preset threshold is, which ensures that more pixel points are retained at higher levels of the pyramid where there are fewer pixel points and information, thereby ensuring the accuracy of similarity calculation.

In some embodiments, if the pixel reference information meets the first preset condition, the processing device 120 may continue to execute operations 420 and 430; otherwise, the processing device 120 may execute process 500.

In 420, in response to the pixel reference information satisfying the first preset condition, the pixel point being not the target pixel point may be determined.

In some embodiments, when it is determined that the pixel reference information of the pixel point satisfies the first preset condition, it can be concluded that the pixel point is not the target pixel point and may be filtered out as a noise point, thus eliminating the need for it to participate in subsequent operation 340 of calculating the initial similarity.

In 430, the pixel value of the pixel point may be set to be the preset value. That is, the processing device 120 may set pixel values of pixel points that are not target pixel points to the preset value. More description of the determination of the preset value may be found in operation 330 and its related description, which is not repeated here.

In the embodiments of the present disclosure, by filtering out pixel points in the image to be matched whose gradient magnitude is less than the preset threshold, the number of pixel points needed to participate in similarity calculation is reduced, greatly reducing the amount of computation, decreasing computation time, and improving image processing efficiency.

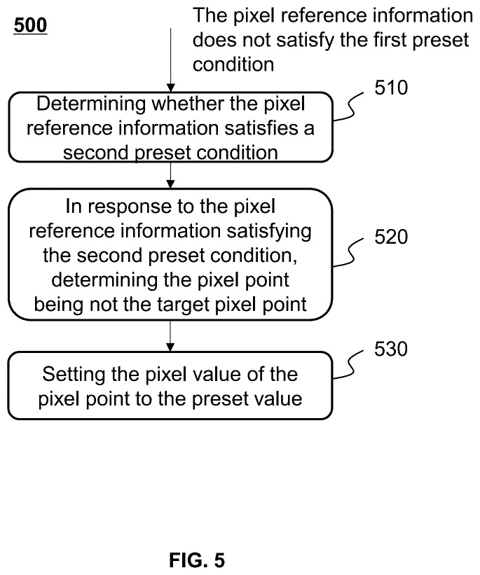

FIG. 5 is a flowchart illustrating an exemplary process for image processing according to some embodiments of the present disclosure. In some embodiments, at least part of the process 500 may be performed to achieve at least part of operation 330 as described in connection with FIG. 3. For example, the processing device 120 or the first determination module 230 may determine whether the pixel point is the target pixel point by executing at least part of the process 500.

In 510, for each of the multiple pixel points in the image to be matched, when the pixel reference information of the pixel point does not satisfy the first preset condition, whether the pixel reference information of the pixel point satisfies a second preset condition may be determined.

The second preset condition may be set based on a comparison between the second reference information of the pixel point and a preset template. In some embodiments, the second reference information may include pixel values of the pixel point and adjacent pixel points of the pixel point. The adjacent pixel points of the pixel point may include eight adjacent pixel points located around the pixel point with the pixel point as a center. The eight adjacent pixel points of the pixel point may be arranged in a clockwise/counterclockwise direction around the pixel point, sequentially referred to as a first adjacent pixel point, a second adjacent pixel point, a third adjacent pixel point, a fourth adjacent pixel point, a fifth adjacent pixel point, a sixth adjacent pixel point, a seventh adjacent pixel point, and an eighth adjacent pixel point. In some embodiments, the second preset condition may be that the second reference information of the pixel point matches the preset template.

In some embodiments, the preset template may include that pixel values of at least some of the eight adjacent pixel points satisfy a third preset condition. The third preset condition may include pixel values less than or equal to the preset value. The preset value is the preset value described in operations 330, 430, and 530. By determining whether the pixel values of at least some of the adjacent pixel points are less than or equal to the preset value, it is possible to ascertain whether the pixel reference information of the pixel point conforms to the preset template, and further, whether the pixel point needs to be filtered out may be determined, making the filtering of pixel points more accurate and improving the accuracy of template matching.

In some embodiments, the preset template may include pixel values of two of the eight adjacent pixel points meet the third preset condition and the two adjacent pixel points are symmetrical relative to the pixel point. FIG. 7 is a schematic diagram illustrating an exemplary preset template according to some embodiments of the present disclosure. As shown in FIG. 7, adjacent pixel points of a pixel P include eight adjacent pixel points located around and centered on the pixel point P. These eight adjacent pixel points are arranged clockwise, sequentially referred to as a first adjacent pixel point 710, a second adjacent pixel point 720, a third adjacent pixel point 730, a fourth adjacent pixel point 740, a fifth adjacent pixel point 750, a sixth adjacent pixel point 760, a seventh adjacent pixel point 770, and an eighth adjacent pixel point 780. A pixel value of the pixel point P is 255. The preset value is 0. In sub-figure a, the first adjacent pixel point 710 and the fifth adjacent pixel point 750 are symmetrical relative to the pixel point P, and both have pixel values of 0, which is equal to the preset value, satisfying the third preset condition. In sub-figure b, the third adjacent pixel point 730 and the seventh adjacent pixel point 770 are symmetrical relative to the pixel point P, and both have pixel values of 0, which is equal to the preset value, satisfying the third preset condition. In sub-figure c, the second adjacent pixel point 720 and the sixth adjacent pixel point 760 are symmetrical relative to the pixel point P, and both have pixel values of 0, which is equal to the preset value, satisfying the third preset condition. In sub-figure d, the fourth adjacent pixel point 740 and the eighth adjacent pixel point 780 are symmetrical relative to the pixel point P, and both have pixel values of 0, which is equal to the preset value, satisfying the third preset condition. In some embodiments, the pixel values of the pixel point and the adjacent pixel points of the pixel point in the image to be matched only need to match any one of the sub-figures in FIG. 7 to consider the pixel reference information of that pixel point as satisfying the second preset condition. Whether the pixel reference information of the pixel point conforms to the preset template based on whether two adjacent pixel points satisfy the pixel value and relative position requirements, which improves the accuracy of pixel point filtering and template matching.

In some embodiments, the preset template may include that pixel values of three of the eight adjacent pixel points of the pixel point satisfy the third preset condition, and the three adjacent pixel points conform to a first pixel point combination, a second pixel point combination, a third pixel point combination, or a fourth pixel point combination. The first pixel point combination is a combination of the first adjacent point, the fourth adjacent point, and the seventh adjacent point; the second pixel point combination is a combination of the third adjacent point, the fifth adjacent point, and the eighth adjacent point; the third pixel point combination is a combination of the first adjacent point, the third adjacent point, and the sixth adjacent point; the fourth pixel point combination is a combination of the second adjacent point, the fifth adjacent point, and the seventh adjacent point.

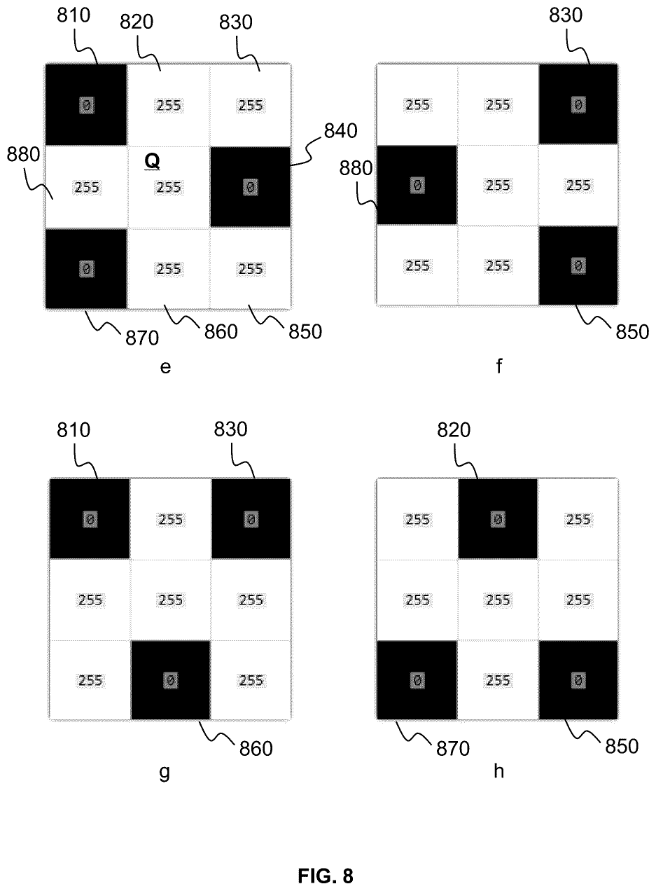

FIG. 8 is a schematic diagram illustrating an exemplary preset template according to some embodiments of the present disclosure. As shown in FIG. 8, adjacent pixel points of a pixel point Q may include eight adjacent pixel points located around the pixel point Q and centered on the pixel point Q. These eight adjacent pixel points are arranged clockwise, sequentially referred to as a first adjacent pixel point 810, a second adjacent pixel point 820, a third adjacent pixel point 830, a fourth adjacent pixel point 840, a fifth adjacent pixel point 850, a sixth adjacent pixel point 860, a seventh adjacent pixel point 870, and an eighth adjacent pixel point 880. A pixel value of the pixel point Q is 255. The preset value is 0. In sub-figure e, the first adjacent pixel point 810, the fourth adjacent pixel point 840, and the seventh adjacent pixel point 870 satisfy the first pixel combination, and their pixel values are all 0, which is equal to the preset value, satisfying the third preset condition. In sub-figure f, the third adjacent pixel point 830, the fifth adjacent pixel point 850, and the eighth adjacent pixel point 880 satisfy the second pixel combination, and their pixel values are all 0, which is equal to the preset value, satisfying the third preset condition. In sub-figure g, the first adjacent pixel point 810, the third adjacent pixel point 830, and the sixth adjacent pixel point 860 satisfy the third pixel combination, and their pixel values are all 0, which is equal to the preset value, satisfying the third preset condition. In sub-figure h, the second adjacent pixel point 820, the fifth adjacent pixel point 850, and the seventh adjacent pixel point 870 satisfy the fourth pixel combination, and their pixel values are all 0, which is equal to the preset value, satisfying the third preset condition. In some embodiments, the pixel values of the pixel point and adjacent pixel points of the pixel point in the image to be matched only need to match any one of the sub-figures in FIG. 8 to consider the pixel reference information of the pixel point as satisfying the second preset condition. Whether the pixel reference information of the pixel point matches the preset template is determined based on whether its three adjacent pixel points satisfy the pixel value requirement and relative position requirement, which improves the accuracy of pixel filtering and template matching.

In FIGS. 7 and 8, the pixel values of the central pixel point and adjacent pixel points that do not satisfy the third preset condition are both 255, which is only an example and not a limitation. By way of example only, the pixel values of the central pixel point and the adjacent pixel points that do not satisfy the third preset condition may not be equal. As another example, at least one of the central pixel and adjacent pixel points that do not satisfy the third preset condition may have a pixel value other than 255, such as a larger pixel value like 254, 250, 247, etc.

In some embodiments, the preset template may include that more than three adjacent pixel points of the eight adjacent pixel points satisfy the third preset condition, and the more than three adjacent pixel points conform to a specific pixel combination. For example, the pixel values of four of the eight adjacent pixel points satisfy the third preset condition, and these four adjacent pixel points conform to the specific pixel combination. The specific pixel combination may be a combination of the first adjacent point, the third adjacent point, the fifth adjacent point, and the seventh adjacent point.

In some embodiments, the third preset condition may be that the pixel values are less than or equal to the preset value, and the difference between the pixel values of adjacent pixel points conforming to the preset template and the preset value is not greater than a first set value. The first set value may be set based on experience, for example, a value greater than 0 and less than 5.

In some embodiments, the third preset condition may be that the pixel value is less than or equal to the preset value, and a sum of the differences between the pixel values of adjacent pixel points conforming to the preset template and the preset value is not greater than a second set value. The second set value may be set based on the first set value, for example, a value not greater than twice the first set value.

In 520, in response to the pixel reference information of the pixel point satisfying the second preset condition, the pixel point being not the target pixel point may be determined. Operation 520 is similar to operation 420, which is not repeated here.

In 530, the pixel value of the pixel point may be set to be the preset value. Operation 530 is similar to operation 430, which is not repeated here.

In some embodiments, after operations 510-530 are executed once, pixel points whose pixel reference information meets the second preset condition are reassigned values, which may update the pixel values of adjacent pixel points of some pixel points that originally did not meet the second preset condition, making these pixel points satisfy the second preset condition. If operations 510-530 are only executed once, these pixel points may be treated as target pixel points and participate in subsequent similarity calculation, which may lead to unnecessary computational overhead. In some embodiments, for pixel points whose pixel reference information does not meet the first preset condition, the processing device 120 may iteratively execute operations 510-530 to traverse them until the fourth preset condition is met.

In some embodiments, the fourth preset condition includes at least one of a ratio of a number of non-target pixel points among the multiple pixel points in the image to be matched to a total number of the multiple pixel points is greater than or equal to a preset ratio threshold, a number of the traversals reaches a preset number, or a duration of the traversals reaches a preset time limit. In some embodiments, the preset ratio threshold, the number of the traversals, and the duration of the traversals may be set based on experience, historical statistical values, or user needs. For example, if the preset ratio threshold is set to 40%, it is believed that reaching this ratio can greatly improve computational efficiency, and there is no need to continue traversing. As another example, if the number of the traversals is set to 3 times, or the duration of the traversals is set to two hours, it is believed that more number or duration of the traversals will only increase unnecessary computational overhead.

In some embodiments, the preset ratio threshold may be related to an edge ratio of the template image (for example, a proportion of edge pixel points in the template image). The higher the edge ratio, the more complex the edge features in the template image, the larger the number of pixel points that need to be retained for subsequent similarity calculation, and the smaller the preset ratio threshold may be.

According to the embodiments of the present disclosure, by further filtering out pixel points in the image to be matched whose pixel values, along with those of their adjacent pixel points, satisfy the preset template, the number of pixel points that need to participate in similarity calculation is further reduced, greatly reducing the amount of computation, decreasing computation time, and improving image processing efficiency.

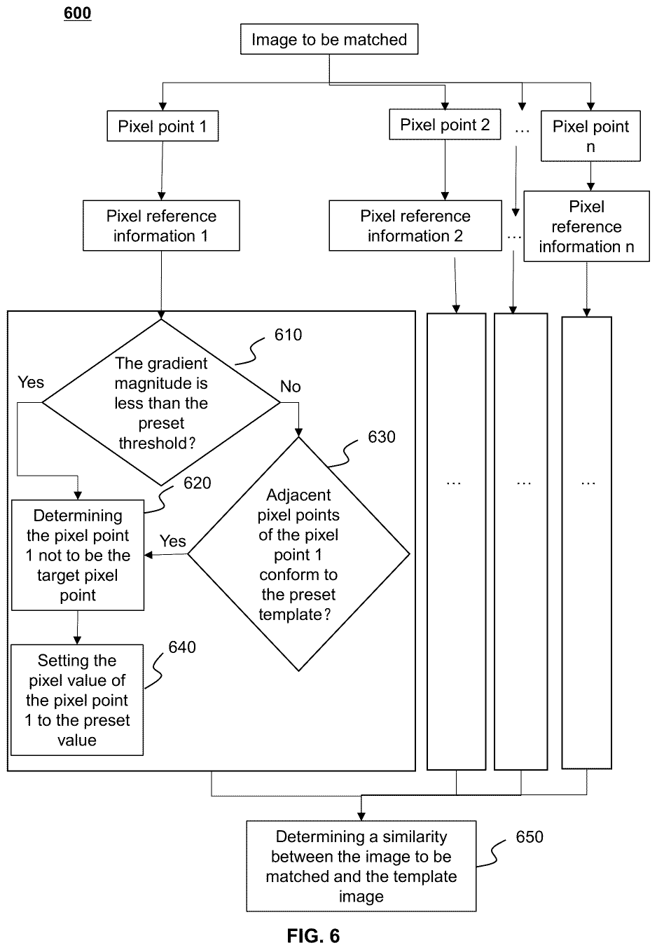

FIG. 6 is a schematic diagram illustrating an exemplary process for image processing according to some embodiments of the present disclosure. In some embodiments, process 600 may be executed by the image processing system 100 and/or the image processing system 200. For example, process 600 may be implemented as a set of instructions (e.g., an application) stored in a storage device (e.g., the storage device 130 illustrated in FIG. 1). In some embodiments, the processing device 120 of the image processing system 100 and/or one or more modules of the image processing system 200 may execute the set of instructions and may accordingly be directed to perform the process 600.

As shown in FIG. 6, the image to be matched may include n (n>2) pixel points, denoted as pixel point 1, pixel point 2, . . . , pixel point n. For each pixel point, the processing device 120 may obtain its corresponding pixel reference information, namely pixel reference information 1, pixel reference information 2, . . . , pixel reference information n. The pixel reference information may include a gradient magnitude of the pixel point (first reference information), and pixel values of the pixel point and adjacent pixel points of the pixel point (second reference information). For each pixel point, the processing device 120 may perform operations similar to operations 610-640 to determine whether it satisfies a preset condition, thereby deciding whether it should participate in the operation 650. The following illustrates this process using pixel point 1 as an example.

In 610, whether the gradient magnitude is less than the preset threshold may be determined.

In some embodiments, the processing device 120 may determine whether the gradient magnitude of pixel point 1 is less than the preset threshold. That is, the processing device 120 may ascertain whether the pixel reference information 1 satisfies the first preset condition. If the gradient magnitude of the pixel point 1 is less than the preset threshold, operation 620 is executed; otherwise, operation 630 is performed. More description of the determination of whether the pixel reference information of the pixel point satisfies the first preset condition may be found in operation 410 and its related description, which is not repeated here.

In 620, the pixel point 1 may be determined not to be the target pixel point.

In some embodiments, when the gradient magnitude of the pixel point 1 is less than the preset threshold, the processing device 120 may determine that the pixel point 1 is not the target pixel point, which means that the pixel point 1 does not participate in the subsequent similarity calculation. The target pixel point is that needs to be involved in the similarity calculation between the image to be matched and the template image. operation 620 is similar to operations 420 and 520, which is not repeated here.

In some embodiments, after executing operation 620, the processing device 120 may proceed to operation 640.

In 630, whether adjacent pixel points of the pixel point 1 conform to the preset template may be determined.

In some embodiments, when the gradient magnitude of the pixel point 1 is greater than or equal to the preset threshold, the processing device 120 may further determine whether the adjacent pixel points of the pixel point 1 conform to the preset template (for example, the templates shown in FIGS. 7 and 8). That is, the processing device 120 may ascertain whether pixel reference information 1 of the pixel point 1 satisfies the second preset condition. Specifically, the processing device 120 may evaluate whether pixel values of at least some (e.g., two, three, four, etc.) adjacent pixel points of the pixel point 1 satisfy a third preset condition, and whether these pixel points satisfy the position requirements of adjacent pixel points in the preset template. If the adjacent pixel points of the pixel point 1 conform to the preset template, operation 620 is executed; otherwise, the pixel point 1 may be determined as the target pixel point. More description of the determination of whether the pixel reference information of the pixel point satisfies the second preset condition may be found in operation 510 and its related description, which is not repeated here.

In 640, the pixel value of the pixel point 1 may be set to be the preset value.

In some embodiments, after determining that the pixel point 1 is not the target pixel point, the processing device 120 may set the pixel value of the pixel point 1 to the preset value, such as a smaller pixel value like 0, 5, etc.

In 650, a similarity between the image to be matched and the template image may be determined.

In some embodiments, after all pixel points in the image to be matched have been evaluated for target pixel points, the processing device 120 may calculate and determine initial similarities based on all target pixel points, and determine the similarity between the image to be matched and the template image based on these initial similarities. More description of the determination of the similarity between the image to be matched and the template image may be found in operations 340 and 350 and its related description, which is not repeated here.

In some embodiments, operation 630 may be omitted. When the gradient magnitude of the pixel point 1 is greater than or equal to the preset threshold, the processing device 120 may determine the pixel point 1 as the target pixel point, which is suitable for scenarios where computational resources are abundant and there is less demand for reducing computational consumption.

The operations of the illustrated processes 300, 400, 500, and 600 presented above are intended to be illustrative. In some embodiments, a process may be accomplished with one or more additional operations not described, and/or without one or more of the operations discussed. Additionally, the order in which the operations of a process described above is not intended to be limiting.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” may mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of the present disclosure are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C #, VB. NET, Python or the like, conventional procedural programming languages, such as the “C” programming language, Visual Basic, Fortran 2103, Perl, COBOL 2102, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (Saas).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, for example, an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various inventive embodiments. This method of disclosure, however, is not to be interpreted as reflecting an intention that the claimed object matter requires more features than are expressly recited in each claim. Rather, inventive embodiments lie in less than all features of a single foregoing disclosed embodiment.

In some embodiments, the numbers expressing quantities or properties used to describe and claim certain embodiments of the application are to be understood as being modified in some instances by the term “about,” “approximate,” or “substantially.” For example, “about,” “approximate,” or “substantially” may indicate ±1%, ±5%, ±10%, or ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

1. A method implemented on a computing device including at least one processor and at least one storage device, comprising:
obtaining an image to be matched, the image to be matched including multiple pixel points;
for each of the multiple pixel points,
obtaining pixel reference information of the pixel point, the pixel reference information including first reference information related to a pixel gradient of the pixel point and second reference information related to pixel values of both the pixel point and adjacent pixel points of the pixel point;
determining, based on the pixel reference information, whether the pixel point is a target pixel point, the target pixel point being a pixel point whose pixel value is not a preset value;
in response to the pixel point being the target pixel point, determining an initial similarity between the target pixel point and a pixel point in a template image; and
determining the similarity between the image to be matched and the template image based on at least one initial similarity corresponding to at least one target pixel point.

2. The method of claim 1, wherein
the determining, based on the pixel reference information, whether the pixel point is a target pixel point includes:
determining whether the pixel reference information satisfies a first preset condition, wherein the first preset condition is set based on a comparison between the first reference information and a preset threshold; and
in response to the pixel reference information satisfying the first preset condition, determining the pixel point being not the target pixel point;
the method further comprises:
setting the pixel value of the pixel point to the preset value.

3. The method of claim 2, wherein the preset threshold is determined based on a candidate feature of the image to be matched, the candidate feature including a contrast and a gradient magnitude statistical feature of the image to be matched.

4. The method of claim 3, wherein the candidate feature further includes a contrast of a candidate region in the image to be matched.

5. The method of claim 4, wherein the candidate feature corresponds to multiple candidate regions in the image to be matched, at least one of shapes or sizes of the multiple candidate regions being different, and the contrast of the candidate region is determined based on a weighted calculation of the contrasts of the multiple candidate regions.

6. The method of claim 2, wherein the preset threshold is determined based on a processing speed requirement and the gradient magnitude statistical feature of the image to be matched.

7. The method of claim 2, wherein
the determining, based on the pixel reference information, whether the pixel point is a target pixel point further includes:
in response to the pixel reference information not satisfying the first preset condition, determining whether the pixel reference information satisfies a second preset condition, wherein the second preset condition is set based on a comparison between the second reference information and a preset template; and
in response to the pixel reference information satisfying the second preset condition, determining the pixel point being not the target pixel point;
the method further comprises:
setting the pixel value of the pixel point to the preset value.

8. The method of claim 7, wherein the adjacent pixel points of the pixel point include eight adjacent pixel points located around the pixel point with the pixel point as a center, the preset template includes pixel values of two of the eight adjacent pixel points satisfying a third preset condition and the two adjacent pixel points being symmetrical relative to the pixel point, and the third preset condition includes the pixel values being less than or equal to the preset value.

9. The method of claim 7, wherein the adjacent pixel points of the pixel point include a first adjacent pixel point, a second adjacent pixel point, a third adjacent pixel point, a fourth adjacent pixel point, a fifth adjacent pixel point, a sixth adjacent pixel point, a seventh adjacent pixel point, and an eighth adjacent pixel point located around the pixel point with the pixel point as a center, the first to eighth adjacent pixel points being arranged in a clockwise/counterclockwise direction around the pixel point, the preset template includes pixel values of three of the eight adjacent pixel points satisfying a third preset condition and the three adjacent pixel points conforming to a first pixel point combination, a second pixel point combination, a third pixel point combination, or a fourth pixel point combination, and the third preset condition includes the pixel values being less than or equal to the preset value; wherein
the first pixel point combination is a combination of the first adjacent point, the fourth adjacent point, and the seventh adjacent point;
the second pixel point combination is a combination of the third adjacent point, the fifth adjacent point, and the eighth adjacent point;
the third pixel point combination is a combination of the first adjacent point, the third adjacent point, and the sixth adjacent point; and
the fourth pixel point combination is a combination of the second adjacent point, the fifth adjacent point, and the seventh adjacent point.

10. (canceled)

11. The method of claim 7, wherein the method further comprises:
performing multiple traversals on pixel points among the multiple pixel points whose pixel reference information does not satisfy the first preset condition until a fourth preset condition is satisfied.

12. The method of claim 11, wherein the fourth preset condition includes at least one of:
a ratio of a number of non-target pixel points among the multiple pixel points to a number of the multiple pixel points being greater than or equal to a preset ratio threshold,
a number of the traversals reaching a preset number, or
a duration of the traversals reaching a preset duration.

13. The method of claim 2, wherein the determining an initial similarity includes:
determining whether pixel values of a preset number of pixel points among the multiple pixel points are the preset value;
in response to the pixel values of the preset number of pixel points all being the preset value, not determining the initial similarity for the preset number of pixel points;
in response to a pixel value of at least one pixel point among the preset number of pixel points not being the preset value, determining the initial similarity for the at least one pixel point.

14. The method of claim 13, wherein the preset number is determined based on a number of pixel points that the at least one processor can process in parallel.

15. A system, comprising:
at least one storage device including a set of instructions; and
at least one processor in communication with the at least one storage device, wherein when executing the set of instructions, the at least one processor causes the system to perform operations including:
obtaining an image to be matched, the image to be matched including multiple pixel points;
for each of the multiple pixel points,
obtaining pixel reference information of the pixel point, the pixel reference information including first reference information related to a pixel gradient of the pixel point and second reference information related to pixel values of both the pixel point and adjacent pixel points of the pixel point;
determining, based on the pixel reference information, whether the pixel point is a target pixel point, the target pixel point being a pixel point whose pixel value is not a preset value;
in response to the pixel point being the target pixel point,
determining an initial similarity between the target pixel point and a pixel point in a template image; and
determining the similarity between the image to be matched and the template image based on at least one initial similarity corresponding to at least one target pixel point.

16. The system of claim 15, wherein the determining, based on the pixel reference information, whether the pixel point is a target pixel point includes:
determining whether the pixel reference information satisfies a first preset condition, wherein the first preset condition is set based on a comparison between the first reference information and a preset threshold; and
in response to the pixel reference information satisfying the first preset condition, determining the pixel point being not the target pixel point;
the method further comprises:
setting the pixel value of the pixel point to the preset value.

17. The system of claim 16, wherein the preset threshold is determined based on a candidate feature of the image to be matched, the candidate feature including a contrast and a gradient magnitude statistical feature of the image to be matched.

18. The system of claim 17, wherein the candidate feature further includes a contrast of a candidate region in the image to be matched.

19. The system of claim 18, wherein the candidate feature corresponds to multiple candidate regions in the image to be matched, at least one of shapes or sizes of the multiple candidate regions being different, and the contrast of the candidate region is determined based on a weighted calculation of the contrasts of the multiple candidate regions.

20. The system of claim 16, wherein the preset threshold is determined based on a processing speed requirement and the gradient magnitude statistical feature of the image to be matched.

21-29. (canceled)

30. A non-transitory computer readable medium, comprising executable instructions that, when executed by at least one processor, direct the at least one processor to perform a method comprising:
obtaining an image to be matched, the image to be matched including multiple pixel points;
for each of the multiple pixel points,
obtaining pixel reference information of the pixel point, the pixel reference information including first reference information related to a pixel gradient of the pixel point and second reference information related to pixel values of both the pixel point and adjacent pixel points of the pixel point;
determining, based on the pixel reference information, whether the pixel point is a target pixel point, the target pixel point being a pixel point whose pixel value is not a preset value;
in response to the pixel point being the target pixel point, determining an initial similarity between the target pixel point and a pixel point in a template image; and
determining the similarity between the image to be matched and the template image based on at least one initial similarity corresponding to at least one target pixel point.
